(19) United States
(12) Patent Application Publication
(10) Pub. No.: US 2016/0259491 A1
(43) Pub. Date: Sep. 8, 2016

(54) SYSTEM AND METHOD FOR AUTOMATIC THIRD PARTY USER INTERFACE ADJUSTMENT

(71) Applicant: Olio Devices, Inc., San Francisco, CA (US)

(72) Inventors: Steven Jacobs, San Francisco, CA (US); Evan Wilson, San Francisco, CA (US); Michael Smith, San Francisco, CA (US)

(21) Appl. No.: 15/058,384

(22) Filed: Mar. 2, 2016

Related U.S. Application Data
(60) Provisional application No. 62/127,621, filed on Mar. 3, 2015.

(51) Int. Cl. G06F 3/0481; H04L 29/08

(52) U.S. Cl. CPC G06F 3/0481; H04L 67/34

(57) ABSTRACT

A method for enabling a third party to dynamically reskin information displayed at a primary user device associated with a user account includes: transmitting a user interface template to a third party device, receiving assets from the third party device, delivering a bundle to a user device, and presenting the user interface based on the bundle.

### CROSS-REFERENCE TO RELATED APPLICATIONS

This application claims the benefit of U.S. Provisional Application No. 62/127,621 filed 3 Mar. 2015, which is incorporated in its entirety by this reference.

### TECHNICAL FIELD

This invention relates generally to the graphical user interface field, and more specifically to a new and useful system and method of simplifying third party adjustment of a user interface in the graphical user interface field.

### BRIEF DESCRIPTION OF THE FIGURES

FIG. 1 is a schematic representation of a variation of the method.

FIGS. 2-5 are a first, second, third, and fourth example of different user interface segments and segment arrangements.

FIG. 6 is a schematic representation of an example of applying the third-party selected graphical assets to a template with predetermined variables assigned to each position.

FIG. 7 is a schematic representation of an example of applying the third-party selected graphics to a template, wherein the third party provides both the variable assignment to the positions and the graphical assets associated with the variable values.

FIG. 8 is a schematic representation of an example of applying the third-party selected patterns and watch hand graphics to a template including predetermined variables assigned to each position and a set of watch hand vectors.

FIG. 9 is a schematic representation of a variation including customizable and restricted template areas, template layers, and automatic association of assets with variables.

FIG. 10 is a schematic representation of a variation including segmentation based on a template and assets received from a third party.

FIG. 11 is a schematic representation of a variation enabling a third-party to select user populations for bundle delivery.

FIG. 12 is a schematic representation of variations of the method.

FIG. 13 is a schematic representation of variations of the method.

FIGS. 14A-D are schematic representations of a first, second, third, and fourth example of digital watch backgrounds that are dynamically generated based on user context.

FIG. 15 is a schematic representation of an example digital watch background at a first time and a second time, respectively, wherein each background is generated based on a first and second set of user context parameter values, respectively.

FIG. 16 is a schematic representation of an example of primary and secondary user device interface skinning using the same graphical asset bundle.

FIG. 17 is a schematic representation of an example of automatic constituent asset determination.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

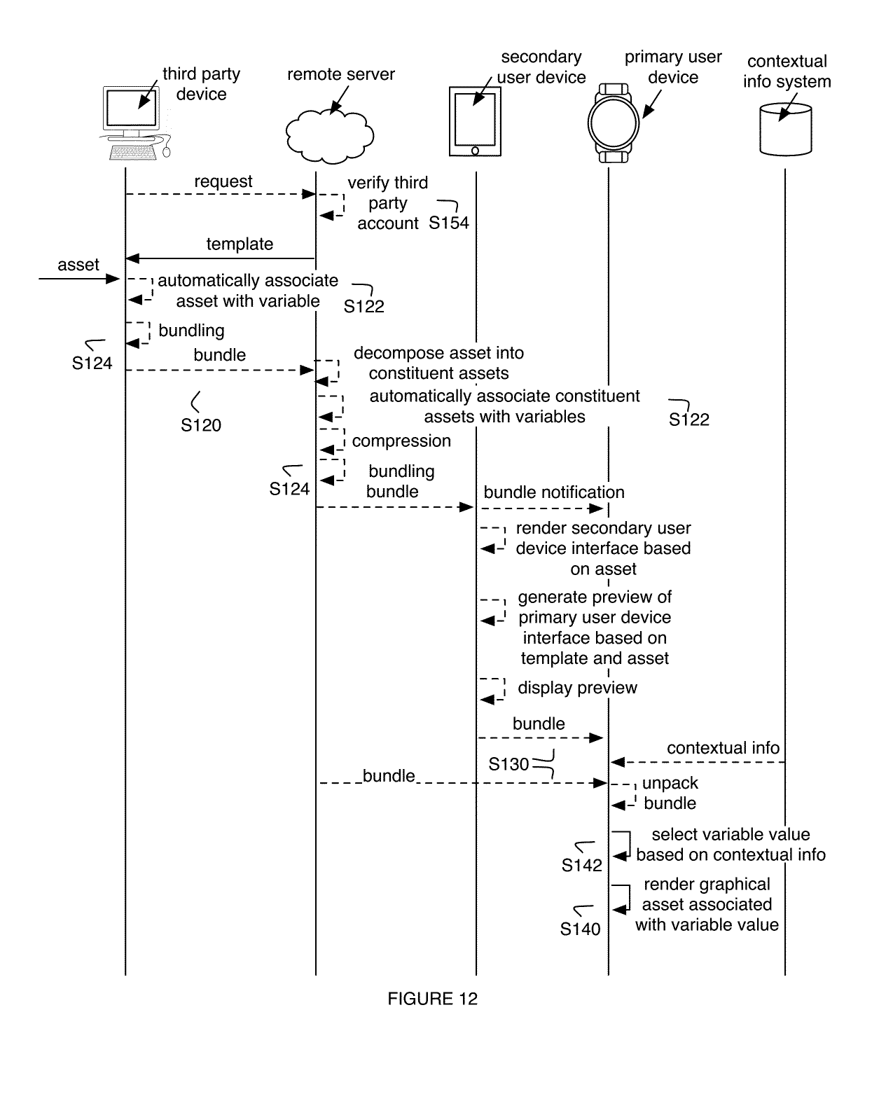

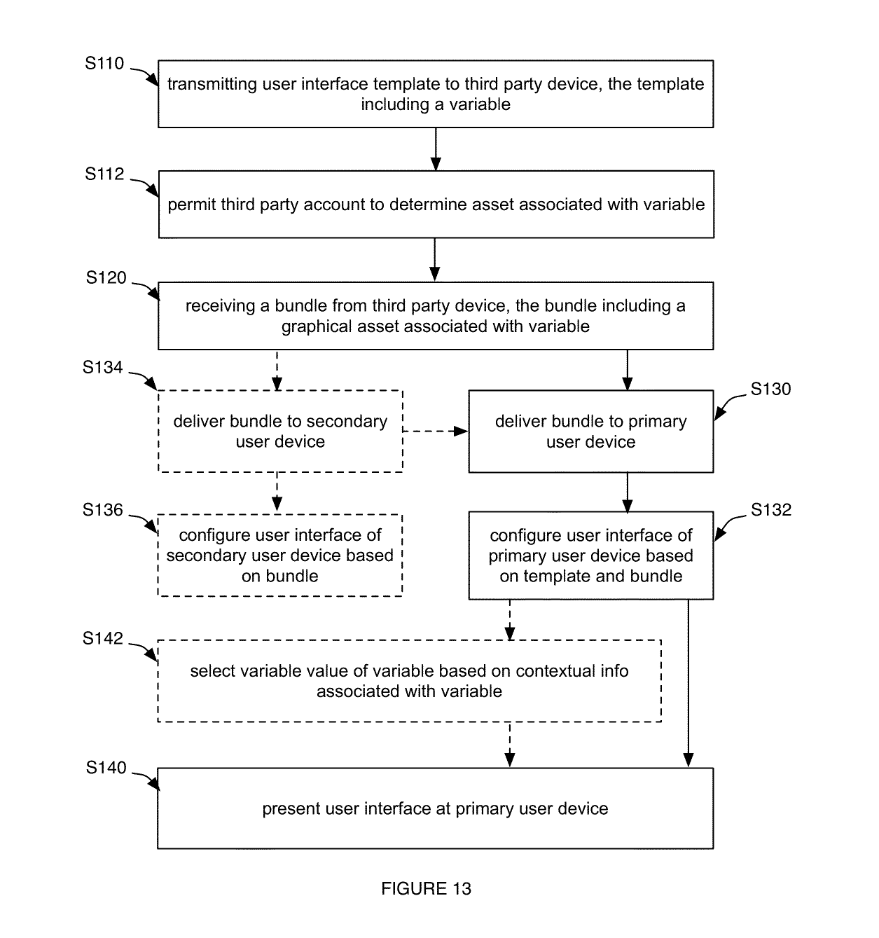

As shown in FIGS. 12-13, the method for enabling a third party to dynamically reskin information displayed at a primary user device includes: transmitting a user interface template to a third party device, receiving assets from the third party device, delivering a bundle to a user device, and presenting the user interface based on the bundle.

The method functions to enable a third party to dynamically configure information displayed at a primary user device of a user. The method is preferably performed with the system described below, but can alternatively be performed with any other suitable system.

The inventors have discovered a mechanism for simplifying how a user interface of a user device can be designed and controlled. Conventional systems require third parties to write software code along with implementing graphical design choices. Such requirements necessitate additional workload and a diverse set of skills. As such, third parties often do not have the capabilities to quickly and appropriately optimize a user interface according to design criteria.

The inventors have responded to these needs in the technological fields of graphic design for contemporary user device interfaces, software design for digital user interfaces, and real-time wireless communication between third parties and users with user devices possessing wireless communication functionality. Further, the inventors have conferred improvements in the functioning of the user devices themselves by effectively enabling third-party customization of user interfaces designed for efficient rendering at user devices. As such, the inventors have discovered approaches to transform the user device to a personalized state tailored to the user.

Specifically, the inventors have discovered solutions to an issue specifically arising with computer technology, namely the lack of a streamlined mechanism for a lay third-party to wirelessly customize a digital display of a user device. The inventors' solutions include solutions necessarily rooted in computer technology by: allowing third parties to generate objects (e.g., graphic images, animations, rules for digital interfaces, etc.) unique to computer technology, and allowing third parties to manipulate the objects (e.g., implementing user interfaces with the graphics, animations, rules, etc.) in a manner unique to computer technology (e.g., through a third-party web application, etc.).

### 2. Benefits.

The method can confer several benefits over conventional methodologies for simplifying third party user interface adjustment in the user interface field user. First, the method can confer the benefit of permitting someone with little to no software knowledge to create a custom software experience across a variety of devices. Software coding and execution can be implemented on the backend, such that third parties can re-skin a user device interface despite restricted or no access to the underlying source code. Thus, third parties can focus on customizing the design and user interface of a user device, in order to optimize user experience and satisfaction.

Second, the method enables third parties to define which users are exposed to which types of user experiences. Third parties can select different user populations to have access to different user interfaces. For example, a third-party can choose to have a metallic-themed user interface be delivered only to smartwatch users with metallic-based bands and/or watch faces. Third parties can therefore personalize user interfaces for different types of users.

Third, the method facilitates multiple avenues of communication between a third party and an end-user. The method can enable third parties to dynamically push updates to the mobile device, refresh content on the mobile device, provide customer service to the mobile device (e.g., by pushing a new bundle to the mobile device, changing the user interface design on the user device, etc.), or enable any other suitable functionality for the third party. For example, the method can enable a third-party to present custom notifications to a user, such as a customized display of appreciation for the user's loyalty to a third-party brand. Such communications between third parties and end-users can be facilitated in real-time to allow an open channel of communication. The method can further simplify the process by enabling third parties to remotely update one or more primary user devices (e.g., through wireless updates, intermediary remote servers, etc.).

Fourth, the method can affect the display of devices beyond a primary user device. This benefit enables a uniform user-experience across different devices. For example, for a third-party selection of a brand logo, the brand logo can affect the displays on both a smartphone and a smartwatch of a user.

Fifth, the method enables third parties and users to configure rules for how a user interface will be rendered at a user device. This benefit empowers third parties and users to configure a user interface to match the inclinations of a user. For example, a third-party can construct rules that re-skin the background of a user interface based on different user situations. A professional background can be employed when a user is in a business meeting. A recreational background can be rendered when the user is in a recreational social setting.

Sixth, varying permission levels and restrictions can be implemented with respect to different types of third parties, which enables third-party experiences tailored to their goals, skills, target user demographics, etc. For example, a “graphic designer” permission level can be implemented with a third-party account associated with graphic designers for a third-party brand. A “developer” permission level can tailor a third-party interface to focus on rule configuration. By personalizing the third-party experience, third parties can better develop an optimized user experience.

In a specific example, a third party designer accesses templates for a user interface of a user device (e.g., a smartwatch). The designer generates graphical assets based on referencing and/or using the templates (e.g., dragging and dropping graphical assets into the template). A bundling system, such as software plug-in on the designer device (e.g., design engine) or a remote computing system, converts the received graphical assets into a bundle. The bundling system can associate the individual graphical assets with individual variables and/or variable values associated with the user interface (e.g., based on the templates). The bundle can be delivered to the user device, which can then unpack the bundle and store the graphical assets in association with individual variables and/or variable values. Subsequently, when the user device calls the variables based on established rules, the new graphical assets from the third party can be rendered in association with the variable in lieu of old graphical assets.

### 3. System.

### 3.1 System Overview.

The method can be performed by a plurality of modules, but can additionally or alternatively be performed by any other suitable module running a set of computational models. The plurality of modules can include: a template module, a user interface configuration module, a bundling module, a context information module, a rendering module, and/or any other suitable computation module. The system can additionally include or communicate data to and/or from: an underlying data database (e.g., storing assets, bundles, source code, templates, variables, rules, etc.), user database (e.g., storing user account information such as purchase history, user device version, current bundles activated, demographic information, user populations associated with the user account, user populations associated with different user devices, associated third parties, associations between secondary and primary user devices, user devices associated with the user account, etc.), third party database (e.g., third party account information such as associated brand, uploaded bundles, permission levels, associated user populations, business relationship information, etc.), and/or any other suitable computing system. Types of user accounts can include user accounts based on status (premium, basic, etc.), user device type, demographic information, and/or any other suitable criteria. Types of third party accounts can include accounts based on third party brand (e.g., smartwatch brand “A”, tablet brand “B”, etc.), third party role (e.g., graphic designer, software developer, sales, marketing, executive, testing, etc.), third party relationship (e.g., manufacturer, retailer, etc.), and/or any other suitable criteria.

Each database and/or module of the plurality can be entirely or partially executed, run, hosted, or otherwise performed by: a remote computing system (e.g., a server, at least one networked computing system, stateless, stateful), a user device (e.g., a primary end-user device, secondary end-user device), a third party device (e.g., a brand partner device), a fourth party device (e.g., a primary device manufacturer, enabler of third-party configuration of primary user device interface), or by any other suitable computing system.

Devices can include a smartwatch, smartphone, tablet, desktop, or any other suitable device. The method can be performed by a native application, web application, firmware on the device, plug-in, or any other suitable software executing on the device. Device components used with the method can include an input (e.g., keyboard, touchscreen, etc.), an output (e.g., a display), a processor, a transceiver, and/or any other suitable component. When one or more modules are performed by the remote computing system, the remote computing system can remotely (e.g., wirelessly) communicate with or otherwise control user device operation. Communication between devices and/or databases can include wireless communication (e.g., WiFi, Bluetooth, radiofrequency, etc.) and/or wired communication.

Each module of the plurality can utilize one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, boostrapped aggregation, AdaBoost, stacked generalization, gradient boosting machine method, random forest method, etc.), and any suitable form of machine learning algorithm. Each module can additionally or alternatively be a: probabilistic module, heuristic module, deterministic module, or be any other suitable module leveraging any other suitable computation method, machine learning method or combination thereof. All or a subset of the modules can be validated, verified, reinforced, calibrated, or otherwise updated based on newly received, up-to-date measurements of the field; past field measurements recorded during the growing season; historic field measurements recorded during past growing seasons, or be updated based on any other suitable data. All or a subset of the modules can be run or updated: once; every time a portion of the method is performed (e.g., every time assets from a third party are received); every time the method is performed; every specified time interval (e.g., in preparation for a public release of user interface themes); or at any other suitable frequency. The modules can be run or updated concurrently, serially, at varying frequencies, or at any other suitable time.

### 3.2 Template Module.

The template module functions to generate templates to aid a third party in customizing a user interface to be rendered. The template module can generate any type of template or template component, and define associations between templates, template components, cards, accounts, devices, users, card positions or virtual areas, variables, and/or any suitable parameter. The template module is preferably operated at a remote server associated with a fourth party, where templates generated at the remote server can be stored and/or delivered to third party accounts. Individual templates can be used by multiple entities, and can be reused multiple times.

In a first variation, templates are manually created (e.g., by a human template designer). In a second variation, templates are automatically created. For example, a list of third party preferences (e.g., a preferred color palette, level of customization, graphics to be used, functionality, variables to be included, associations with different elements, etc.) can be received by a fourth party. The preferences can then be used as input into a template-generating model (e.g., machine learning model, rule-based model, etc.) that outputs one or more templates in accordance with the third party preferences. Additionally or alternatively, templates can be generated with respect to user preferences, design limitations (e.g., device limitations), and/or any suitable criteria. Automatic generation of templates can be based on tracked data (e.g., user usage data, third party usage data, survey data, demographic data, etc.). However, the template module can otherwise develop templates.

### 3.3 User Interface Configuration Module.

The user interface configuration module functions to provide a tool for one or more accounts to customize user interface information to be displayed at one or more user devices. The user interface configuration module is preferably leveraged by a third party, but can be employed by a user and/or any suitable entity. The user interface configuration module can be accessed at internet-accessible web interface, at a third party device (e.g., an application running on the third party device), at a user device, and/or at any suitable component. Different instances of the user interface configuration module can be created for different entities, where the different instances can vary with respect to aesthetic, features, level of customizability, and/or other characteristics. The different instances of configuration interfaces can be predetermined, automatically determined, dynamically adjusted and/or created in any suitable manner based on any characteristic of a individual, account, device, brand, or other entity.

In a first variation, the user interface configuration module includes a streamlined configuration interface. The streamlined interface presents templates, variables assigned to template positions, and possible variable values associated with the variable. A user of the streamlined interface is restricted to upload graphical images to be associated with variable values of variables assigned to template positions, where the graphical images will be rendered at an end-user interface. The aesthetic and functionality of the streamlined interface can be tailored for simplicity in order to facilitate efficient graphic design. In a second variation, the user interface configuration module can include a developer configuration interface tailored to a software developer. For example, the interface can enable access to source code and rules underlying templates, template components, and the rendering of user interfaces. In a third variation, the user interface configuration module can include an end-user configuration interface, where end-users can configure aspects of the user interface most relevant to the end-user. The end-user configuration interface is preferably accessible at the end-user device that will have its user interface configured. The end-user configuration interface can include the ability to preview the user interface design at the end-user device that will be rendering the user interface. Alternatively, the end-user configuration interface can include preview options for user interface designs at any suitable end-user device. The end-user interface can include rule configurations, graphic options, and/or any suitable design options. However, the user interface configuration module can include any suitable configuration interface.

### 3.4 Bundling Module.

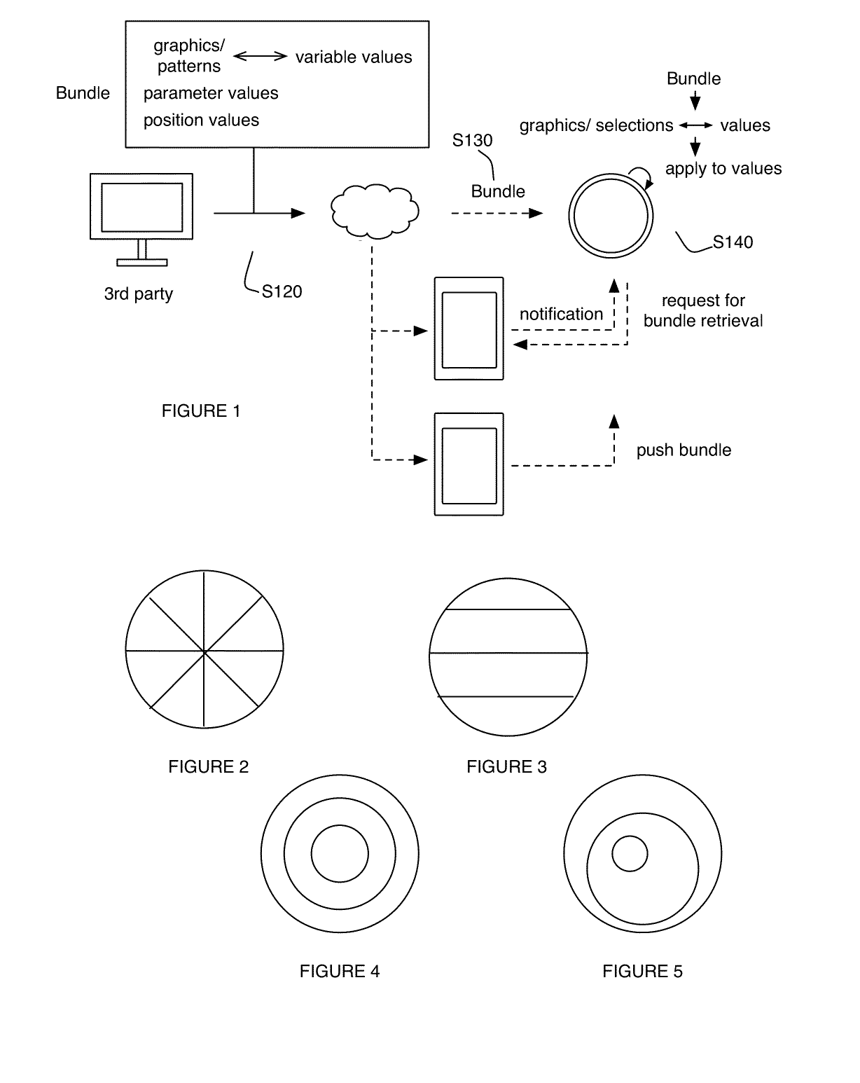

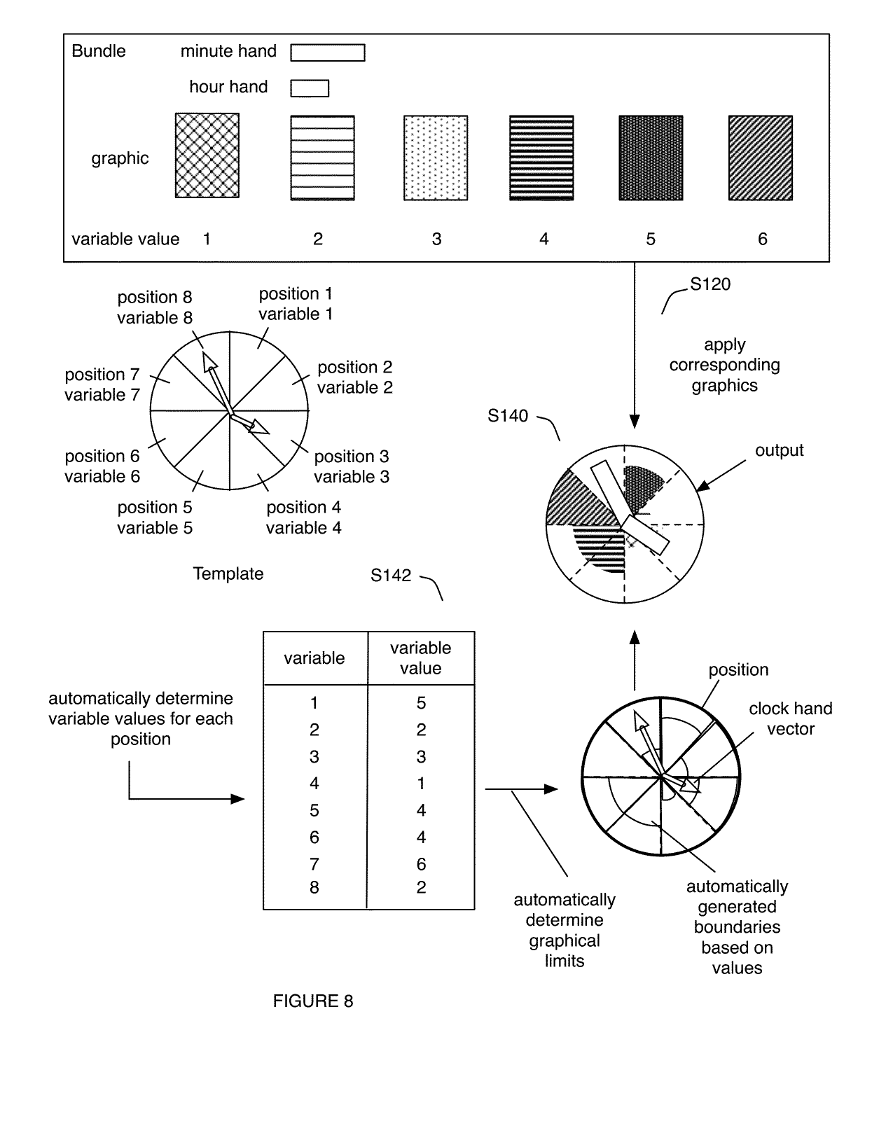

The bundling module functions to consolidate assets into a package tailored to be deployed by a user device in generating a user interface. As shown in FIGS. 1, 6-8, and 11, a bundle can include graphics, parameter values, position values, user population selections, rules, relationships between template components, and/or any suitable asset. The bundling module can perform any suitable processing step, including: associating components (e.g., asset to variable associations), compression, file conversions, extraction (e.g., deconstructing a composite asset into constituent assets), and/or other appropriate processing technique. The bundling module is preferably executed by a bundling system. In a first variation, the bundling module is implemented at a third party device. For example, a third party can configure a user interface template at an application operating on a third party device, and the same application can bundle the third party-determined assets for upload to a fourth party remote server. In a second variation, the bundling module is implemented at a remote computing system (e.g., set of remote servers). For example, a third party can transmit one or more composite and/or individual assets to a remote server (e.g., via a web browser), and the remote server can process the assets in outputting a bundle for delivery to a primary user device. In a third variation, the bundling module is implemented at a secondary user device. For example, a third party can upload assets to a remote server, which can then deliver the assets to a secondary user device to perform bundling, and the output can be pushed by the secondary user device to a primary user device to render a user interface in accordance with the bundle. However, the bundling module can be otherwise implemented.

### 3.5 Context Information Module.

The context information module functions to extract contextual parameters to be used in determining how variables are rendered at a user interface. Contextual parameters are preferably extracted at a user device (e.g., primary, secondary, etc.), but can be determined at fourth party remote server and/or any suitable component. Contextual parameters are preferably associated with variable values, where variable values of a variable can be selected based on the extracted contextual parameters.

Contextual parameters can include content stream parameters (e.g., volume, type, frequency, size of received content from content streams, etc.), sensor parameters (e.g., heart rate, blood glucose level, physical activity level, location, etc.), situational parameters (e.g., time of day, date, etc.), composite parameters, user-created parameters, and/or any other suitable parameter. Contextual parameters can be on a per-time (e.g., regarding the last minute, hour, day, month, year, etc.), per-user, per-account, per device, and/or any suitable basis. Contextual parameters defined on a per-time basis can include parameters characterizing the past, present, and/or future (e.g., predicted amount of content for a future time frame).

Mechanisms for extracting contextual parameters can be predetermined (e.g., manually defined equations for calculating contextual parameters based on received content stream data), automatically determined (e.g., determining the most relevant contextual parameters for a variable based on feature selection approaches with a machine learning model), and/or otherwise determined.

In a first variation, context information can be received at a secondary device (e.g., smartphone), and the information can be pushed to a primary device (e.g., smartwatch) in communication with the secondary user device. Contextual parameters can be the received information and/or can be derived from the received information. Values of variables can then be selected based on the contextual parameters, and graphical images associated with the selected variables can be rendered on the smart watch. For example, social network notifications can be received at a smartphone, and the notification information can be pushed to the smartwatch. The notification information can include the type of notifications received (e.g., a friend request, a missed web call, a received document, etc.), which can be used as a basis to select variable values of a variable indicating the importance level of the notifications. A variable value of “high importance” can be graphically represented with red color, and a variable value of “low importance” can be graphically represented with green color. In a second variation, context information can be directly received at a primary user device, which can subsequently extract contextual parameters and select variable values based on those contextual parameters. In a third variation, contextual parameters can be determined in any manner disclosed in application Ser. No. 14/644,748 filed 11 Mar. 2015, which is incorporated herein in its entirety by this reference. However, the contextual parameter values and/or variable values can be otherwise determined.

### 3.6 Rendering Module.

The rendering module functions to render a user interface of a user device. The rendering module is preferably implemented at the user device corresponding to the user interface to be rendered. Alternatively, the rendering module can be implemented at a secondary user device, where the secondary user device can render a user interface to be graphically presented at a primary user device. However, any suitable entity can leverage the rendering module, and the rendering module can be executed on any other suitable device. The rendering module preferably generates the user interface in accordance with a bundle including composite and/or individual assets, where the bundle is associated with the user interface. In a first variation, the rendering module renders a user interface of a primary user device, based on the bundle. In a second variation, a single bundle can be used in influencing the displays of both a primary and a secondary user device (example shown in FIG. 16). In a third variation, the rendering module can generate virtual previews of how one or more bundles would be implemented in affecting user interfaces rendered on different user devices. However, the rendering module can otherwise render a user interface.

### 4. Data Structures.

The system can be used with a set of data structures. Data structures can include: templates, positions, variables, variable values, rules, assets, bundles, and/or any other suitable data structure. In a first variation, the data structures are predetermined (e.g., by a fourth party). In a second variation, the data structures are automatically generated. For example, a third party can drag-and-drop a graphic image for designing a template for a home screen of a smartwatch, and the necessary data structures can be automatically created for rending the graphic image at the home screen. In a third variation, data structures can be generated by third parties. For example, a third party can utilize a user interface configuration tool provided to the third parties, the tool enabling third parties to create data structures in accordance with the customizability permissions afforded to the third parties. In this variation, the data structures can be assets included in the bundle delivered to user devices. However, the data structures can be otherwise determined or defined.

### 4.1 Data Structures: Template.

The user template preferably defines a set of positions within the user interface, and can additionally or alternatively associate one or more variables with each position. The templates can be associated with a card (e.g., a notification card, a forecast summary card, a home card, incoming call, missed call, etc.), a feature (e.g., alarm, navigation, weather, timer, user-downloaded feature, calls, voicemail, location, email, schedule, entertainment, health & fitness, news, social, music, messaging, etc.), a universal design element (e.g., a background), or with any other suitable user interface component. Templates can be additionally or alternatively be associated with a set of rules, an account, a third party, a user, a device, a device type, and/or any other suitable entity.

The user interface template can be predetermined, automatically generated, received in the bundle, or otherwise determined. Template components can include: positions, layers, variables, variable values, virtual regions, rules, and/or any other suitable component. The positions defined by the user template can be arcuate (e.g., with radial boundaries), radial (e.g., with arcuate boundaries), along three-dimensions, or otherwise defined. In one example as shown in FIG. 2, the substantially circular user interface can be segmented into a plurality of arcuate positions. Each segment can span substantially the same number of degrees, or can span a different number of degrees. In a second example, the substantially circular user interface can be segmented radially into a plurality of concentric positions, as shown in FIG. 4. In a third example, the substantially circular user interface can be segmented linearly into a plurality of linear positions, as shown in FIG. 3. The positions are preferably substantially static (e.g., cannot be changed by the user), or can alternatively be adjustable.

Each position on the template can be assigned one or more variables. The variable can be assigned to the position by the template, by the bundle (e.g., based on the position information), by the user, or assigned to the position in any other suitable manner. The value of the variable assigned to the position preferably determines which graphic is rendered in the respective position. However, the positions can be otherwise populated with graphics.

Multiple template positions can be grouped to form a virtual area of the template. The template positions of a virtual area can be contiguous, non-contiguous, or otherwise related. The virtual areas can each be associated with one or more permission levels (e.g., permission levels defining whether or not a third party can configure the virtual area), where a virtual area and/or different features of the virtual area can be customizable, restricted, or associated with any suitable control level. Virtual areas can be associated with one or more template components. Virtual areas can take the shape of a triangle, square, circle, polygon, arc, radial segment, and/or any other suitable shape. Multiple virtual areas can be adjacent, separate, above, below, coaxial, parallel, perpendicular, radially aligned, arcuately aligned, and/or defined in any suitable relationship. Alternatively, the template can define virtual volumes (e.g., three-dimensional regions), which can possess any of the above-discussed characteristics of virtual areas. However, any suitable virtual region can be defined by the template.

A template can define customizable and/or restricted virtual areas. Customizable virtual areas are preferably configurable by third party accounts at third party device. With respect to a customizable virtual area, customizable features can include: associated variables, associated graphical assets, rules, position, shape, and/or any other suitable feature. Restricted virtual areas are preferably not configurable by third party accounts. The permission level associated with a virtual area can be defined on a per-account, per-device, per-user, and/or any other basis. The customizability level of a virtual area is preferably defined by a fourth party (e.g., defined based on type of third party account associated with the fourth party service). Alternatively, the permission levels can be predetermined (e.g., based on rules), automatically adjusted, defined by a third party (e.g., a third party administrator for the third party accounts), a user, and/or be determined in any other suitable fashion. In one example, templates defining customizable and restricted virtual areas are transmitted to a third-party account. The customizability level of the virtual areas can include the ability to determine graphical assets associated with the virtual areas. For example, the third-party uploads graphical images associated with the customizable virtual areas, and the targeted end-user device renders the graphical images at the user interface positions associated with the virtual areas.

Third parties can control the graphical representation of the template and/or template components on the third party device. Templates and/or components can be rotatable, moveable, and manipulated in any suitable manner to facilitate third party customization of the templates. As third parties customize templates, third parties can preview the aesthetic of a modified template on different user devices (e.g., on the third party device, web browser, web application, etc.). Third parties can thus preview how an end-user would experience a user interface designed by the third party. However, a third party can interact with graphical representation of the template in any suitable manner.

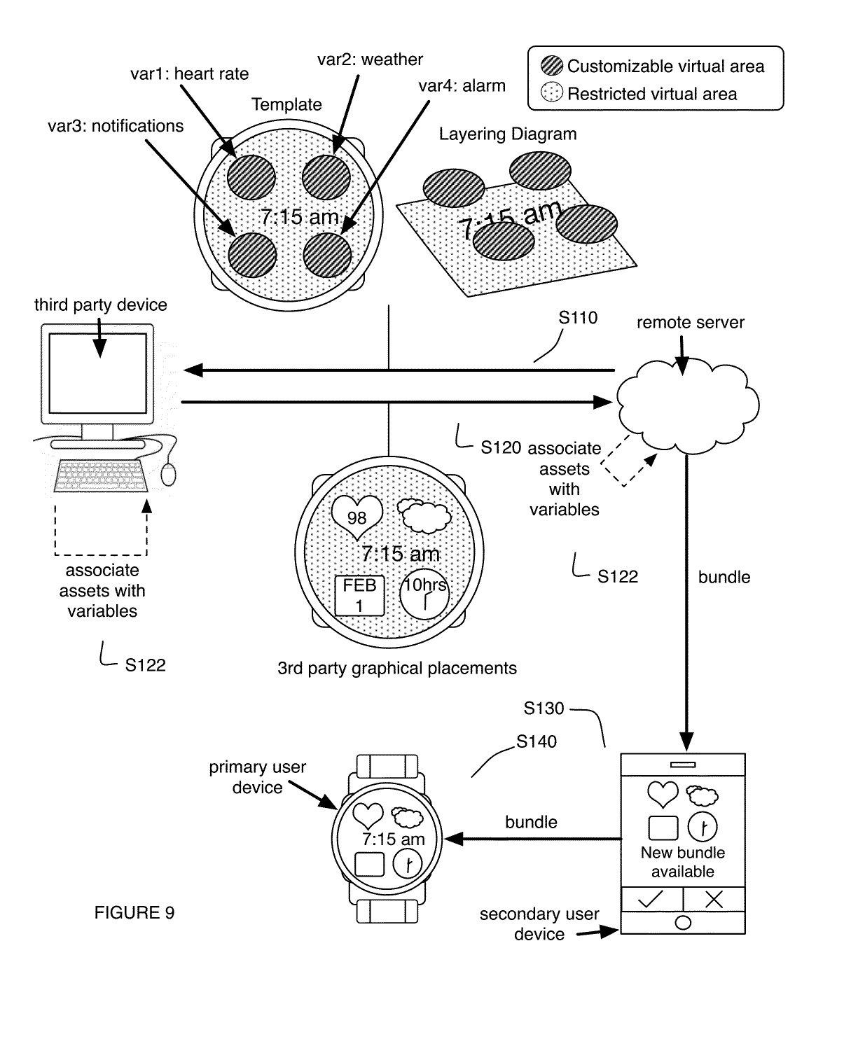

As shown in FIG. 9, in a first variation, the template includes multiple layers, where each layer includes a plurality of positions on the layer. Any number of layers can be defined by a template, and layers are preferably stacked to form a card of the user interface. Layers can be two-dimensional, three-dimensional, and/or take any suitable shape. Entire layers, portions of layers, and/or layer positions can be associated with any suitable template component. For example, a variable can be associated with a first layer position of a first layer. When a variable value associated with the variable is selected by the user device, a graphical asset associated with the variable value can be rendered at the first layer position. In examples, the card can be that described in U.S. application Ser. No. 14/644,748 filed 11 Mar. 2015, which is herein incorporated in its entirety by this reference. However, the card can be any other suitable card.

In a second variation, different template types can be defined for different types of devices. Template types can differ based on the number and type of template components included with the template. For example, templates for a smartwatch display can possess smaller dimensions than templates for a tablet display. Alternatively, a single set of templates can be used for multiple devices. For example, a given template and the associated third party configurations of the template can be converted to accommodate different device types. However, templates can be defined in any suitable manner to accommodate devices differing along any granularity level (e.g., smartphone vs. smartwatch, smartwatch type 1 vs. smartwatch type 2, OS version A on smartwatch type 1 vs. OS version B on smartwatch type 1, etc.). 4.2 Data Structures: Variable.

Variables are preferably associated with template positions, but can be associated with any suitable template component. Variables can include content parameters, content stream parameters (e.g., volume of content, frequency of content, types of content, etc.), third party parameters (e.g., weather, etc.), or any other suitable content variable. A variable can be associated with a single or multiple variable values. The variable values associated with a variable can include discrete values or continuous values. Variable values can be per unit time, per content stream, per content source, or be segmented in any other suitable manner. In a specific example, the variable can be a parameter of a user-associated content stream. The user-associated content stream can be a smartwatch content stream (e.g., a notification stream, application stream, media type stream, etc.), a mobile device content stream, a social networking system stream, or any other suitable content stream associated with the user associated with the smartwatch. In a second specific example, the variable can be the weather, wherein the variable value can be the weather at a given time (e.g. rainy, sunny, foggy, etc.).

Each variable value can be associated with a graphical asset, wherein the graphic associated with the value for the variable is subsequently rendered in the positions assigned with the variable value. The graphic is preferably associated with the variable value in the bundle, but can alternatively be otherwise associated with the variable value. A third party preferably uploads custom graphics that can be automatically associated with variable values. Additionally or alternatively, graphics to be associated with variable values can be predetermined by a fourth party, user and/or any suitable entity.

### 4.3 Data Structures: Rule.

Rules preferably control how components of the user interface will be configured and/or implemented, but can otherwise control any suitable aspect of a user interface. Rules can be set for any type of template component and for any feature of a template component type. Rules can be associated with different permission levels, and such permissions can be established on a per-rule, per-account, per-device, and/or any other suitable basis.

Types of rules are preferably created by a fourth party, where aspects of the rules can be customized by third parties or users. However, any suitable entity can create and/or control rules. A set of customizable rules associated with a template is preferably delivered to a third party along with the template, but options for rule customization can be transmitted to a third party at any suitable time. With respect to receiving a third party's preferences for rules, the preferences can be received in a configuration file, at a third party web application, and/or through any suitable channel.

In a first variation, the rules include template rules. Template rules can include rules for timing (e.g., when to render a user interface based on the template, when to display a card associated with the template, etc.), content displayed (e.g., which variables associated with a template are displayed, template positions to display variables), relationships between templates, (e.g., determining that card “A” associated with template “A” will be displayed subsequent to card “B” associated with template “B”), and/or any other suitable type of rules associated with a template.

In a second variation, the rules include variable rules. Variable rules can include rules for graphical display (e.g., which graphic to display for the variable, when to display which graphic, positioning on the user interface, which variable to display on a given card, etc.), variable values (e.g., how to select a variable value, when to select a variable value, basing variable values on different criteria such as contextual information, etc.), relationships between variables (e.g., relative weighting of different variables in an equation for determining which graphic to display, hierarchy for which variable gets priority in being displayed in association with a virtual area of a template, etc.), and/or any suitable type of rules associated with a variable.

### 4.4 Data Structures: Asset.

Assets are preferably third-party determinations affecting how a user interface of an end-user device is configured and/or rendered. Alternatively, assets can be generated by a user, fourth party, and/or any other suitable entity. Assets can be associated with any template component at any granularity level (e.g., associated with a variable, a variable value, a characteristic of a variable value, etc.).

Assets can include graphical assets, scripts, rule configurations, and/or any other suitable determination that influences a user device display. Graphical assets can include graphics, patterns, icons, animations, videos, option selections (e.g., font typography, size, etc.), and/or any other suitable static or moving image that can be associated with a template component. The graphics can have the same dimensions as the template positions (e.g., same arcuate degree, same radius, etc.), same dimension ratio, different dimensions, or be otherwise related to the template positions. The graphics dimensions can be predetermined and/or restricted, or be unconstrained, such that the third party can send any suitable graphic in the bundle. The graphic can be resealed for rendering, rendered to scale (e.g., wherein a portion of the image is retained), or be otherwise edited in response to receipt. The graphical assets can include images (e.g., vector images, raster images, etc.); selections of predetermined values for different parameters, such as the font typeface, font size, font style, text colors, background colors and/or textures, borders, color combinations, dimensions, animation parameters (e.g., animation coordinates, speed, paths, timing, easing formulas, color change endpoints, graphics morphs, etc.), post-processing parameters (e.g., graphic fading with age, blending adjacent graphics, graphic blending with the background), or values for any other suitable parameters.

Each asset can be associated with one or more position values, such as template position identifiers, pixel values, card or content identifiers, card or content stream identifiers, or any other suitable values for any other suitable position parameter. The position values can be associated with variables (e.g., weather, content stream parameters, etc.), template identifiers, or be associated with any other suitable piece of information. Each asset can be associated with one or more variables or variable values. In one variation, the asset is automatically associated with the variable or variable value assigned to the template position that the asset is associated with. However, the assets can be associated with any other suitable information. In variations, assets can be automatically generated (e.g., wherein the third party can drag and drop graphics at certain positions; wherein the graphics and/or parameter values can be automatically generated based on a reference image or theme, wherein the graphical asset is retrieved from a user photo-stream or social networking system account, etc.), manually generated, or generated in any other suitable manner.

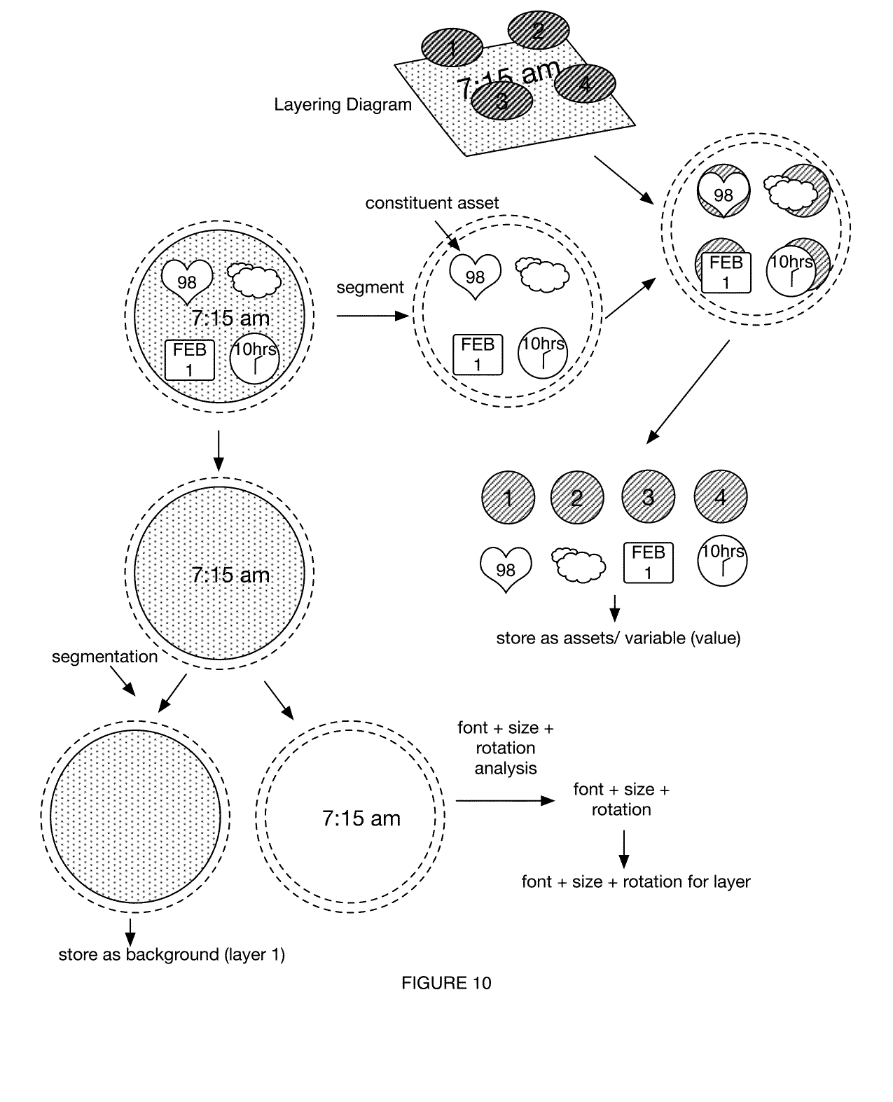

Assets are preferably generated and transmitted by a third party device and received at a remote server, but can otherwise be created or communicated. In a first variation, assets can be received in the form of a customized layer (e.g., populated template). The layer can act as a composite asset including multiple constituent assets. For example, a third party can customize a layer template by assigning graphical images to different customizable virtual areas of the layer template, wherein the graphical image is automatically associated with the variable or variable value associated with the respective virtual area by the template. As shown in FIG. 10, the third party can upload the customized layer (e.g., a single image of the layer, multiple images of different portions or perspectives of the layer, text files indicating layer characteristics, drop-down selections at a web application, etc.) to a bundling system, which can deconstruct the composite asset into constituent assets (e.g., separate graphical images, associated positions for the graphical images, associated fonts, etc.). The composite and/or constituent assets can be stored, processed, bundled, and/or otherwise manipulated.

In a second variation, assets can be received as constituent assets. For example, a third party can upload a compressed archive file including a plurality of individual assets. The constituent assets can be pre-assigned (e.g., by the third party) to variables and/or variable values, but can alternatively be automatically assigned to the variables and/or variable values (e.g., based on shape analysis, template matching, etc.), or otherwise associated with the variables and/or variable values. In a first example, the system receives individual constituent assets at each of a set of template positions (e.g., wherein the assets are dragged and dropped into a virtual template), and automatically assigns the variable and/or variable value associated with the respective template position to the respective constituent asset. In a second example, the system receives the asset in association with a variable assignment or variable value assignment from the user. In a third example, the system receives an asset from the third party, identifies the asset as a constituent asset (e.g., based on graphical parameters, such as shape and size), and identifies the variable and/or variable value associated with the constituent asset (e.g., based on the graphical parameters, such as by matching the asset to other assets associated with the variable, classifying the asset, etc.).

In a third variation, assets can be received in the form of a layer stack. A layer stack can take the form of a flat image (e.g., a single image representative of a one or more stacked layers), a three-dimensional graphical representation, textual data indicating characteristics of the layer stack, and/or any suitable form. A customized layer stack can be processed to extract individual composite layers, associated constituent assets, template position parameters, associated template components, and/or any other suitable data. However, the constituent layers and assets of the layer stack can be otherwise extracted and processed.

### 5. Method.

As shown in FIGS. 12-13, the method for enabling a third party to dynamically reskin information displayed at a primary user device includes: transmitting a user interface template to a third party device, receiving assets from the third party device, delivering a bundle to a user device, and presenting the user interface based on the bundle.

### 5.1 Transmitting Template.

Transmitting a template S110 functions to deliver a template to be used by a third party for configuring a user interface to be rendered at a user device of an end-user. One or more templates are preferably transmitted by a remote server to a third party device associated with a third party account. However, any suitable components can send and/or receive templates. The template can be accessed and/or configured at a web interface, an application operating on a user device (e.g., a native application, a plug-in tool, etc.) and/or other suitable component.

Templates can be transmitted at any suitable frequency and at any suitable time point. In one variation, new templates are available at a web interface as the new templates are generated. In a second variation, templates are transmitted to a third party in response to a third party pull request. In a third variation, third parties (e.g., at a third party account, at an email account of a third party, etc.) are notified of the availability of templates. In a fourth variation, a template is transmitted in response to a third party or user purchasing the template. In this variation, templates can be available for purchase at a template marketplace.

Transmitted templates can include any number or combination of template components. Templates can be transmitted along with examples (e.g., reference templates, reference themes), instructions (e.g., textual instructions for how to configure a template), and/or other suitable supplemental data.

In a first variation, a template pack is transmitted, where the template pack includes a pool of templates that can be customized. In a first example, a third party can select a subset of the templates in the template pack, and only selected templates are transmitted to the third party. In a second example, the entire template pack can be transmitted to a third party. A third party can choose which templates to customize, and the relevant end-user interface will be only be affected by the customized templates. In a second variation, transmitted templates can require a third-party input before permitting a third party to upload data. In a third variation, the selection of templates to be transmitted will be automatically determined based on criteria (e.g., third party subscription status, third party brand, device types, etc.). However, any suitable template can be transmitted to the third party in any other suitable manner.

### 5.2 Receiving Assets.

Receiving assets from a third party S120 functions to obtain assets used in a bundle for configuring a user device interface. Assets are preferably received by a third party device associated with an authorized third party account (e.g., at the user interface module), but can additionally or alternatively be received at a remote server, the bundling system, or at any other suitable endpoint. Assets are preferably received wirelessly through, for example, a third party upload of assets to a fourth party remote server. Additionally or alternatively, assets can be received through wired means. However, assets can otherwise be received. Temporally, assets can preferably be received by a third party at any time and/or at any frequency. However, receipt of assets can be restricted to certain time frames (e.g., when a fourth party is rolling out new bundles, during certain months, etc.) and/or frequencies (e.g., single upload of assets per day).

Received assets can include composite assets (e.g., a customized layer, template, layer stack, image) and/or individual assets (e.g., graphical assets, scripts, rule configurations, etc.). Updates or modifications to existing assets can additionally or alternatively be received. However, any suitable asset and/or asset preference can be received. Assets received can include assets applicable across multiple templates, bundles, themes, devices, user accounts, or any other suitable platform. Additionally or alternatively, asset applicability can be restricted on different bases. For example, a third party can upload a first set of assets applicable to a first bundle, and the same upload can include a second set of assets applicable to a second bundle. In another example, a third party can upload a graphical asset to be implemented with user interfaces across multiple user device types. However, received assets can otherwise be associated.

In a first variation, a push style of asset communication can be employed. In this variation, third parties can push assets and/or associated data to a fourth party remote server. For example, a third party can actively transmit assets to a fourth party independent of requests from a fourth party. In a second variation, a pull style of asset communication can be implemented. For example, at time intervals, a fourth party can submit pull requests for third parties to transmit assets. Examples of time intervals include when a marketplace for interface themes is updating, time frames in which users are to expect bundle updates, at the beginning of a week, month, and/or any suitable time interval.

5.2.A Receiving Assets: Associating Assets with Variables.

Receiving assets S120 can additionally or alternatively include associating assets with variables S122, which functions to determine which assets to implement with which variables. Associating assets with variables is preferably performed at a remote server, but can be performed at a third party device, user device, and/or other suitable component. Associations between assets and variables are preferably determined in response to receiving the assets from a third party. Alternatively, assets can be associated with variables at a third party device (e.g., at an interface configuration application running on a third party device) prior to receiving the assets. However, asset association with variables can be performed before or after bundling, before or after transmission of a bundle to a user device, and/or at any other suitable time.

In a first variation, assets are manually associated with variables. In this variation, the variables are preferably associated with a template received by the third party, and the third party preferably configures and associates the assets with the variables. In a first example, the file name of an asset can be mapped to a variable associated with the file name. A third party can, for instance, assign a file name of “alarm_bg.png” to a graphical image, and based on the file name, the graphical image will be employed in rendering a smartwatch alarm background. In a second example, a third party can associate assets with variables from a pool of predefined variables (e.g., from a drop-down selection menu). The pool of predefined variables can be tailored to a template, a bundle, an account, and/or other suitable component. As shown in FIG. 9, in a third example, a visual representation of a template can include variables graphically represented at different template positions. A third party can assign assets to variables by selecting the graphical representation of the variable (e.g., dragging and dropping a graphical image to the location of the variable).

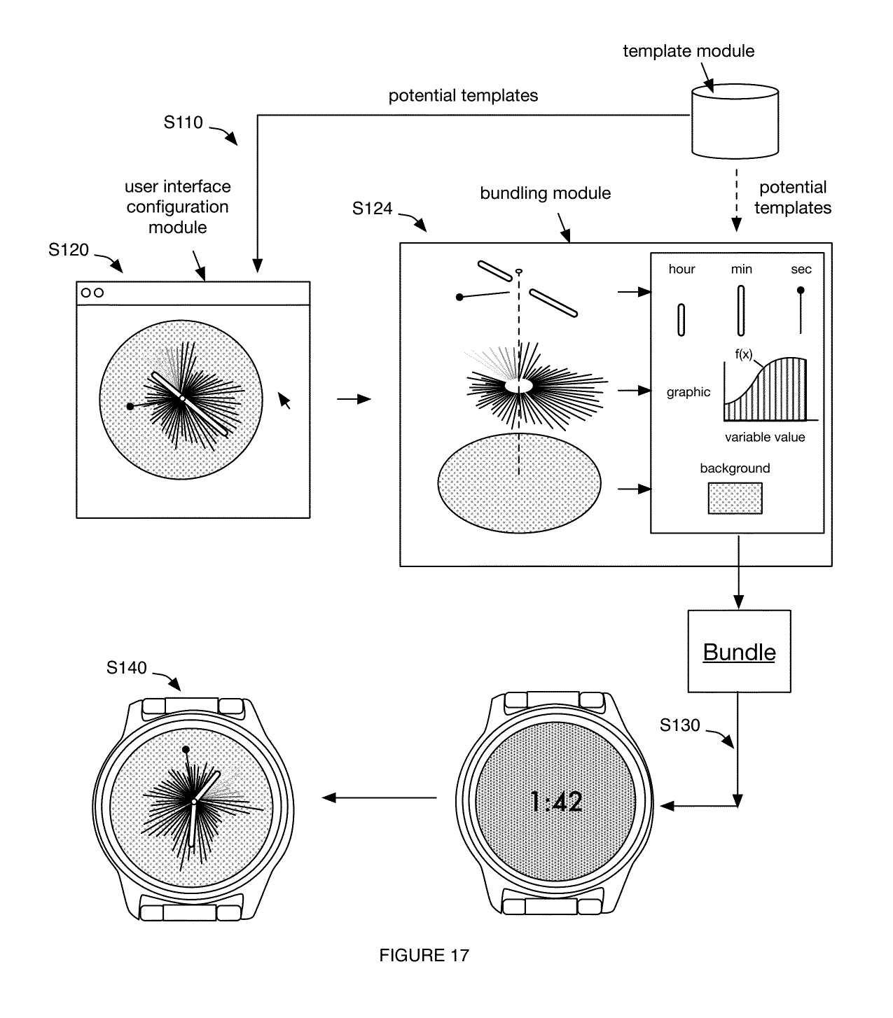

In a second variation, assets can be automatically associated to variables based on the template position at which an asset is placed. Template position information can include: coordinates, layer at which the graphical asset was placed, layer position, proximity to customizable areas of the template, position at which a midpoint of the graphical asset lies, and/or any suitable template position information. In this variation, automatically associating assets with variables can include processing a received asset into constituent assets (e.g., processing a composite asset of a layer into graphical assets associated with the layer). Assets to process can be defined at any suitable granularity level (e.g., processing templates, layers, virtual areas, etc.). In a first example, processing the received asset into constituent asset includes: identifying a region and/or boundary on a flat image corresponding to a defined region and/or boundary in a template; associating graphical assets within the image region and/or boundary with the variables associated with the region and/or boundary in the template. In a second example, processing can include: identifying boundaries for each constituent asset; determining a general location of a constituent asset within a received layer; associating the constituent asset with a template variable within the same general region on the template. Identified boundaries can be non-overlapping, overlapping, and/or otherwise related. In a third example (specific example shown in FIG. 17), processing can include: segmenting a constituent asset into a background region and a foreground region; associating the foreground region with a first graphical asset of the constituent asset; associating the background region with a second graphical asset of the constituent asset. In a specific example, when the customized layer is received as a single image, the bundling system can segment the layer foreground from the layer background, segment the foreground into constituent assets (e.g., based on physical or digital separation within the image, amount of overlap with a set of predefined virtual areas, etc.), identify the relative position of each constituent asset in the image (e.g., layer stacking position, position within each layer, etc.), and associate each constituent asset with the variable or variable value associated with the respective position within the layer template. Alternatively, the bundling system can classify each constituent asset (e.g., using a trained classification model, etc.) and associate the constituent asset with the variable or variable value associated with the class, or otherwise associate constituent asset with the template position, variable, or variable value. The bundling system can additionally store the layer background in association with a background layer for the template.

In a third variation, assets can be automatically associated with variables or variable values based on a machine learning model. A training sample for the model can include a graphical asset, one or more associated variable labels corresponding to a designer's actual goals for the asset, and associated features. Features can include: graphical features (e.g., identifying the content of the graphic through machine vision, dimensions, shape, image segmentation characteristics, etc.), position information, type of asset, user tags, metadata (e.g., time of receipt, size of assets, etc.), template information (e.g., template type, etc.), and/or any other suitable feature. The output of the model can be an association of an asset with one or more variables. However, other models can be used in automatically associating assets with variables.

### 5.2.B Receiving Assets: Bundling.

Receiving assets S120 can additionally or alternatively include bundling S124, which functions to package assets into a bundle tailored to be deployed by a user device in generating a customized user interface. Bundling is preferably performed at a remote server associated with a fourth party, but can fully or partially be performed at the third party device or at any suitable component.

In a first variation, bundling includes processing the assets to accommodate the target user interface constraints. Such processing can include: graphical asset file conversions (e.g., conversions to specified image formats, to specified video formats, etc.), resizing (e.g., resizing graphical assets to fit user interface dimensions, resizing to meet file size requirements, etc.), correlating asset functionality with user interface interaction possibilities (e.g., modifying asset functionality to accommodate touch, pressure, swipe, keyboard, and/or other interaction possibilities, etc.), and/or other suitable processing to optimize asset implementation with different user interfaces.

In a second variation, bundling can include determining the rendering rules by which a given user interface will present a user interface. The rendering rules are preferably based on rule determinations by a third party, fourth party and/or user, but can be additionally or alternatively based on other suitable criteria. In one example, a user device is configured to incorporate multiple bundles in rendering the user interface. The rendering rules can dictate how the multiple bundles are prioritized or otherwise ordered (e.g., rendering specific bundles at specific times, events, transactions, etc.), where bundles or portions of bundles can be rendered in preferential order.

In a third variation, bundling includes storing information associated with the bundle and/or assets. The information can be stored at a remote server, at a fourth party device, and/or any suitable location.

In a fourth variation, bundling includes verifying the bundle, using a security key or other security mechanism. The security key can be provided by a manufacturer, the third party, or any other suitable party. In a fifth variation, bundling includes packaging relevant assets and associated files into an archive file (e.g., a zip file, a rar file, etc.) to be delivered to a user device.

### 5.3 Delivering a Bundle to a User Device.

Delivering one or more bundles to one or more user devices S130 functions to send the required data for a customized user interface to be presented at a user device. A bundle is preferably delivered to a secondary device, which can then transmit the bundle to a primary device. For example, a bundle can be transmitted from a fourth party remote server to an end-user smartphone on a WiFi connection. The smartphone can then push the bundle to a smartwatch through a Bluetooth wireless connection between the devices. Alternatively, a bundle can be delivered directly to a primary user device. However, any suitable component can deliver a bundle to any suitable user device in any suitable manner.

Temporally, a bundle can be made available and delivered to selected user populations after a bundle has been verified to meet bundle requirements (e.g., no solicitous images, no unauthorized modification of the bundle, satisfactorily meeting user interface requirements, etc.). Additionally or alternatively, a bundle can be delivered after establishing pricing for a bundle, displaying a preview to users, verifying a user population that can access the bundle, uploading to a user interface theme marketplace, and/or at any suitable time. Additionally or alternatively, a bundle can be delivered to the user device after a user population selection is received from the third party, wherein the user device is part of the selected user population. However, the bundle can be delivered at any other suitable time.

A user device preferably unpacks the bundle in response to receipt, and implements the assets (e.g., graphics, parameter values, position values, rules, configuration files, etc.) and/or any other suitable information from the bundle. A bundle can be unpacked by a secondary user device, a primary user device, and/or any suitable component. For example, a secondary user device can receive a bundle, unpack the bundle, configure the constituent bundle components, and deliver the configured components to a primary user device for rendering. The bundle is preferably automatically unpacked by the receiving device, but can alternatively be unpacked in response to user authorization receipt or the occurrence of any other suitable unpacking event.

In a first variation, bundle notifications can be transmitted to user devices in order to notify the user of the availability of bundles to download. In a first example, a remote system receives the bundle from the third party and sends a bundle notification to a secondary user device (e.g., smartphone, tablet, etc.) associated with a primary user device. The secondary device then notifies the primary device, and the primary device can retrieve the bundle from the remote system. In a second example, the remote system can receive the bundle from the third party and send the bundle to the primary user device. The secondary device can send a bundle notification to the primary device, and the primary device can retrieve the bundle from the secondary device. In a second variation, a bundle can be automatically pushed from a secondary device to a primary device whenever a bundle is delivered to a secondary device. In a third variation, delivering a bundle to a user device is dependent on a particular communication link with the user device. For example, a remote server associated with a fourth party can deliver a bundle to a user device only when the user device is connected through a WiFi connection. In another example, a secondary user device with a bundle can only transmit the bundle to a primary device when an existing Bluetooth connection is identified between the devices. In a fourth variation, delivering a bundle to a user device can depend on a user device performance metric. User device performance metrics can include a state of charge, memory usage, processor usage, and/or any suitable performance metric. For example, a bundle can be delivered to a user device when a state of charge above 50% is detected. In a fifth variation, delivering the bundle can depend on the time of day. For example, a bundle can be delivered during normal sleeping hours when a user is not using the device. In a sixth variation, a bundle can be delivered based on one or more contextual information parameters of the user device. For example, a bundle can be delivered when the number of notifications and/or upcoming cards is below a predetermined threshold. In another example, a bundle can be delivered based on a user calendar, such as when a user has no upcoming calendar events. In a seventh variation, a bundle can be delivered after a user purchase of a bundle. A third party, fourth party, and/or other suitable entity can configure pricing, marketing, and/or other characteristic associated with a market transaction of a bundle.

### 5.4 Presenting a User Interface.

Presenting a user interface S140 functions to display a customized user interface in accordance with the bundle. Temporally, presenting a user interface is preferably in response to a user device effectuating a user device feature, where the feature is preferably associated with a template transmitted to a third party. For example, a user device can have a music-playing feature, and a background template associated with the feature can be transmitted to a third party. A third party can upload assets associated with the template, and a corresponding bundle can be delivered to the user device. When the user device effectuates the music-playing feature (e.g., when a user operates the user device to play a song), the user device can present the music user interface based on the bundle. Additionally or alternatively, presenting a user interface can be performed in response to a specific card being used, to a user performing a specific function, to a contextual parameter exceeding a threshold, to rules being met, and/or in relation to any suitable event or criteria.

In a first variation, presenting a user interface is based on satisfaction of user preference rules. User preference rules for selecting a user interface to present can include: time (e.g., different interfaces for nighttime vs. daytime, etc.), social situation (e.g., professional meeting, social get-together, etc.), physical activity (e.g., heart rate, standing, sitting, etc.), and/or any other suitable rule. In one example, a user can set a preference to adjust a user interface based on the professionalism level associated with calendar events on the user device (example shown in FIG. 16). When the calendar indicates that the user is at work, a professional user interface is presented. When the calendar indicates that the user is at home, a recreational user interface is presented. In a second variation, a user interface can be presented based on third party-established rules. For example, a third party can set a rule to transmit a customized notification at the user interface for special events (e.g., birthday, anniversary, etc.). In a third variation, selection of when to present a particular user interface can be dynamically determined based on contextual parameters, inherent device parameters (e.g., presenting a minimal user interface when the user device state of charge is below a threshold, sensor data, etc.), and/or other suitable information. In one example, a machine learning model can be leveraged in predicting a type of user interface to display based on user device usage, contextual parameters, user preferences and/or other suitable features.

The presented content of a user interface is preferably based on constituent bundle components of an unpackaged bundle (e.g., assets, rules, templates, template components, and/or other suitable information). The presented content can be derived from a designer template transmitted to a third party, a card template specific to a user device type, and/or other suitable reference data. Configuration and/or presentation of a user interface can be performed at a secondary user device, primary device, and/or other suitable device.

In a first variation, a user interface is rendered by populating a template with graphical assets in accordance with position parameters, rules, and/or other suitable information. In a first example, a user interface can render a template with third party-selected graphical assets assigned to customizable areas of the template, where the relevant graphical assets are rendered at the corresponding template positions of the customizable areas. In a second example, the user device can render a card, including: determining the variable value for each variable on the card, identifying graphical assets corresponding to each determined variable value, and populating the card with the relevant graphical assets located in card positions corresponding to the respective variables. However, the user interface can be dynamically skinned using the bundle assets in any other suitable manner.

In a second variation, a user interface is rendered according to the display preferences of a user. Display preferences can include color scheme, font, personalized graphics, preferred complications, etc. Users can preview how a given bundle would influence a user interface under the constraints of the user preferences. The user can view such previews at any suitable user device.

In a third variation, a user interface is rendered in accordance with bundle rules establishing relationships between multiple bundles and/or bundle components stored at a user device. For example, a first bundle can contain customized user interface templates for a calculator feature of a user device, but not a navigation feature. A second bundle can include customized user interface templates for the navigation feature. The user device can implement the first bundle when a user device effectuates the calculator feature, and the user device can implement the second bundle when the navigation feature is effectuated. In another example, multiple bundles include different assets associated with the same user device function. Bundle rules can dictate which bundle and/or bundle assets to deploy.

### 5.4.A Presenting a User Interface: Determining Variable Values.

Presenting a user interface S140 can include determining values for variables of the user interface S142, which functions to determine which third party graphical selection to render in each user interface position. Determining variable values preferably includes automatically populating each position with a graphic associated with the respective variable value by the bundle, which functions to skin the user interface with the third party graphical selections. Automatically populating each position can include determining the variable assigned to the position, determining the value for the variable, retrieving the graphic associated with the variable value, and displaying the retrieved graphic in the position. However, the user interface can be otherwise populated.

Determining variable values is preferably based on extracted contextual parameters and variable rules defined by a third party, fourth party, user, and/or other suitable entity. Rules for determining variable values can be predetermined, dynamically determined, or otherwise determined. In one example, a user device stores previously selected variable values and associated metadata, such that a future selection of variable value can be based on previously selected variable values (e.g., the most recently selected value for a variable, the overall variable history of selected values, what value was selected at a particular time, location, etc.).

Temporally, determining variable values is preferably performed in response to a card type being presented at the user interface, where the variable is associated with the card type. Additionally or alternatively variable values can be selected based on predicted card types to be used in the near future by a user device, or can be selected independent of card types. However, variable values can be determined at any suitable time.

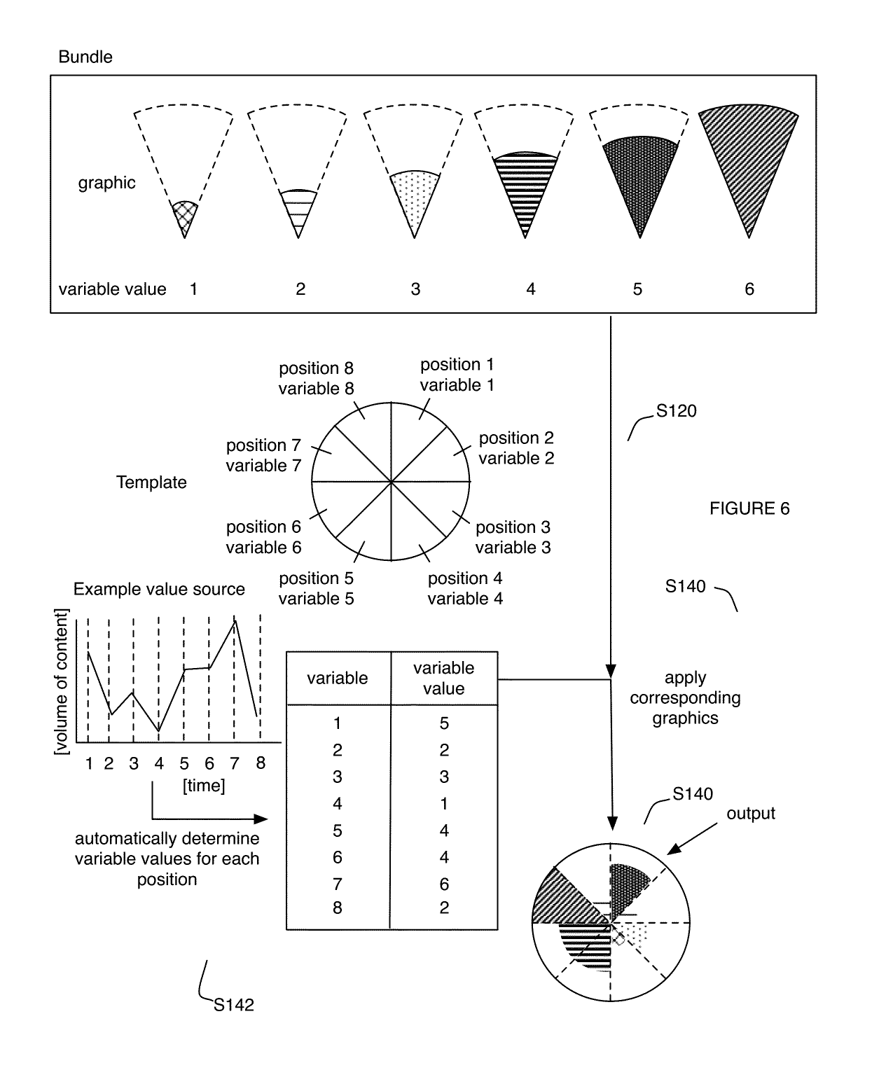

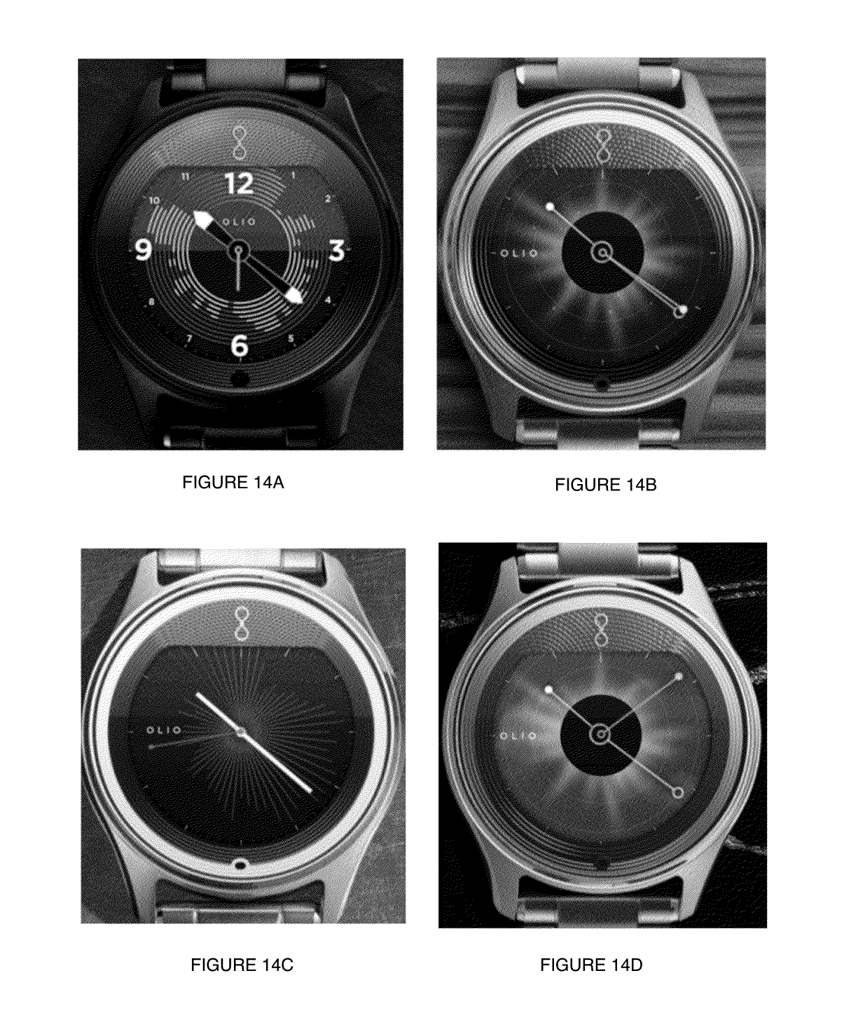

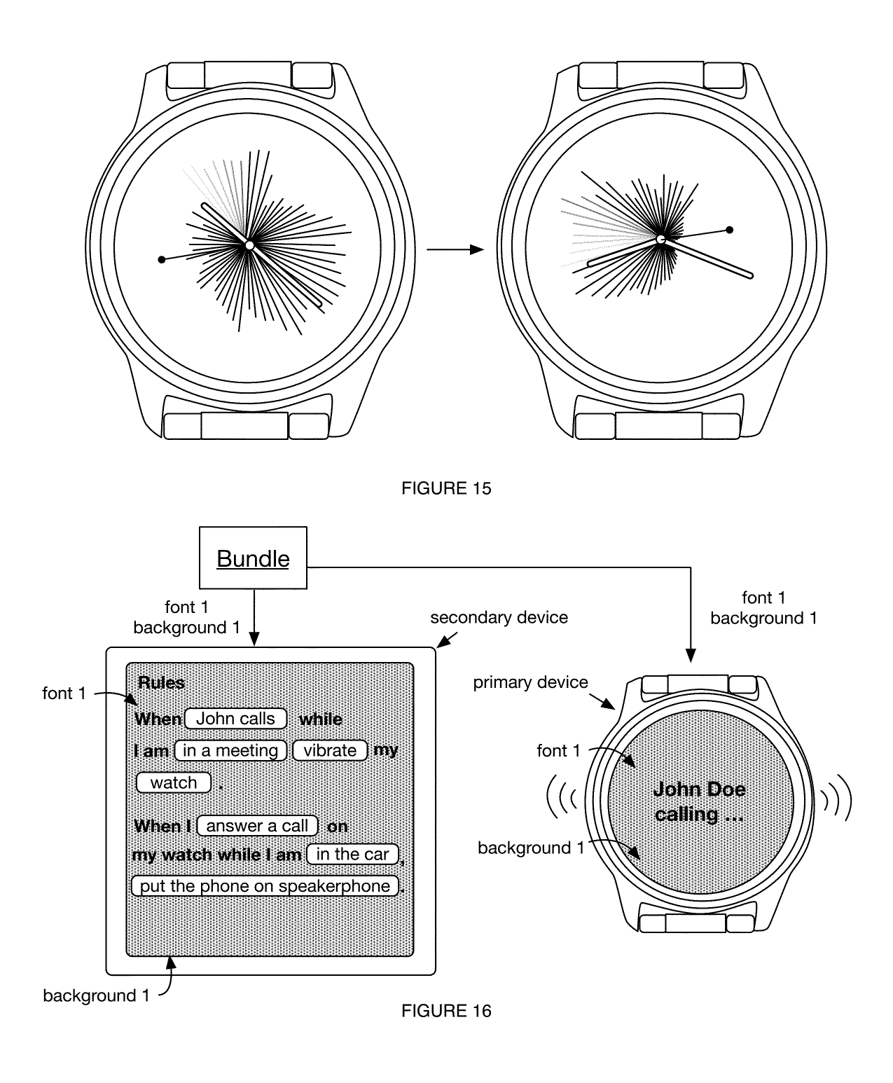

In a first example, similar to that shown in FIGS. 6, 14A-D, and 15, the template (e.g., a home card template or background) includes a plurality of arcuately defined positions, wherein each position is assigned a different variable. In a specific example, the circular user interface is segmented into 12 arcuate segments, each representing an hour, wherein the variables assigned to the segments cooperatively represents the content stream parameters for the past 12 hours. In a specific example, each variable is a content stream parameter for a different timeframe (e.g., the volume of content received during the last hour, the volume of content received during the previous hour, etc.), wherein successive positions are associated with successive timeframes. The graphic associated with the parameter value can be retrieved and rendered in the user interface position associated with the parameter. For example, a first graphic can be retrieved and rendered for a first content volume or frequency and a second graphic can be retrieved and rendered for a second content volume or frequency. In this example, the template can additionally include a set of watchface elements (e.g., representation of an analog or digital watch), wherein each watchface element can be associated with a graphic (e.g., predetermined or received in the bundle). For example, the bundle can include a first graphic for the hour hand of the watchface and include a second graphic for the minute hand of the watchface. In another example, the bundle can specify the font, size, kerning, and/or color of the digital watch numbers, wherein the digital watch numbers can be rendered according to the bundle specifications.

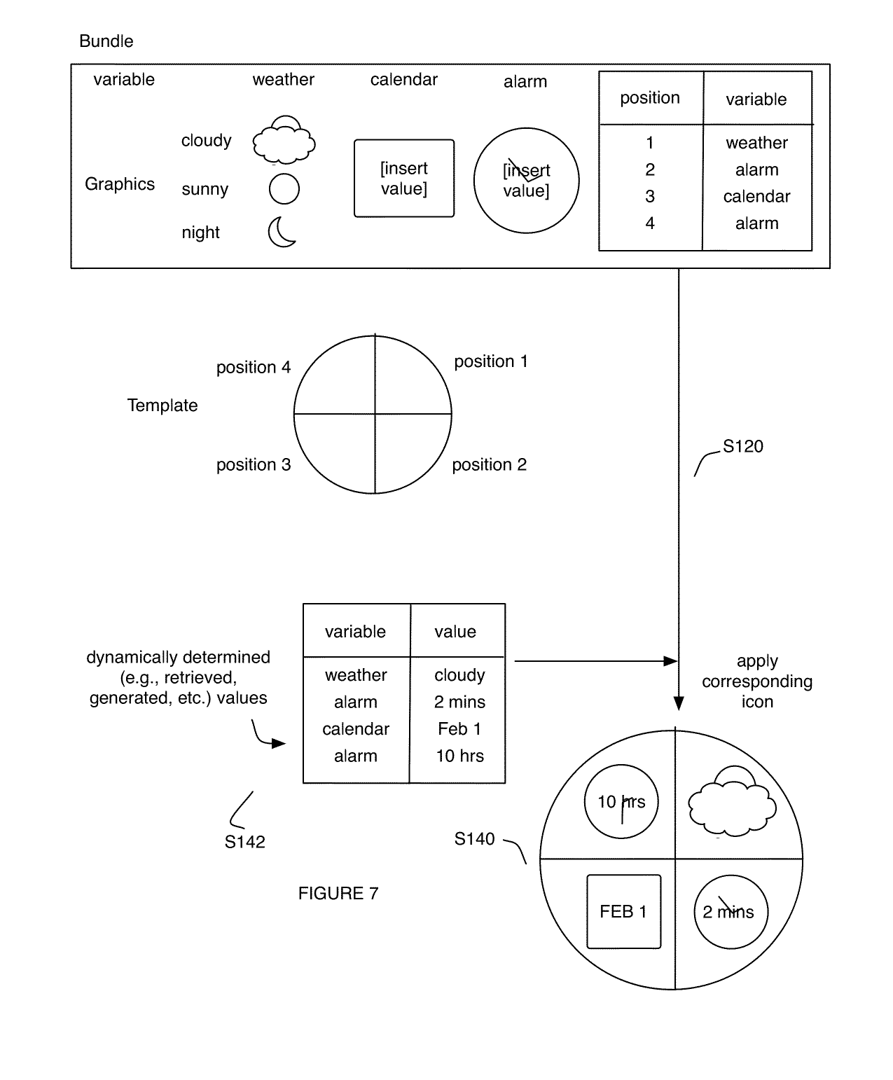

In a second example, similar to that of FIG. 7, the template (e.g., forecast summary card) includes a plurality of arcuately defined positions, wherein each position is associated with a variable by the bundle. In a specific example, the template can be segmented into four positions, wherein a variable (e.g., weather, upcoming events, or active timer) is assigned to each quadrant by the bundle. A graphic associated with the value of the variable is preferably retrieved (e.g., from the bundle or from information extracted from the bundle) and rendered in the variable position specified by the bundle. However, the user interface can be skinned based on the variable values in any other suitable manner.

### 5.5 Verifying an Account.

The method can additionally or alternatively include verifying a third party account S154, which functions to identify whether a third party account is authorized to customize a user interface. Verifying an account is preferably performed before transmitting templates to the third party device accessing the account. Additionally or alternatively, verifying an account can be performed before, during, or after a third party uploads an asset and/or bundle. Verification can also be performed prior to making a bundle available to the target user population. However, verifying an account can be performed at any suitable time. In variations, verification can include two-factor authorization, IP verification, administrator confirmation, and/or any other suitable verification mechanism. Verifying an account preferably includes validating the third party password for the account, verifying the third party device attempting to upload the template or attempting to update the user device graphics, or otherwise verifying the third party account.

### 5.6 Selecting a User Population.

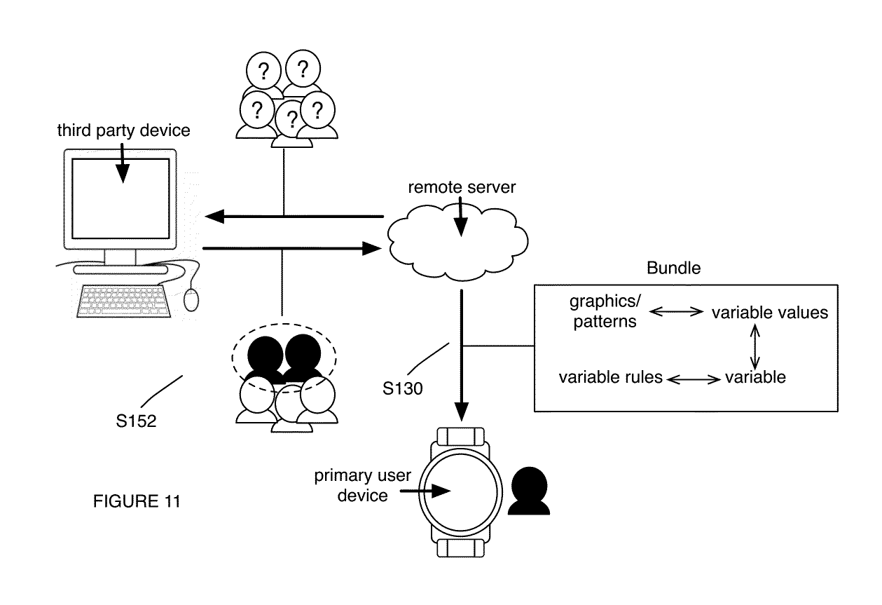

As shown in FIG. 11, the method can additionally or alternatively include selecting a user population S152, which functions to define a set of users who can access a bundle. Selecting a user population can include permitting a third party to select the user population, but a fourth party and/or other suitable entity can select associate a user population with a given bundle.

Temporally, options for selecting user populations can be transmitted to a third party before, during, or after template transmission to the third party. Third parties can select user populations at a third party configuration interface, a third party device, and/or ay any suitable component. For example, a third party can have access to a population selection interface presenting an overview of bundles associated with the third party, and potential user populations to select to associated with a given bundle. The population selection interface can enable a third party to map bundles to user populations. Permitting a third party to select a user population is preferably in response to verification of the third party account. However, user population selection can be performed at any suitable time.

User populations to be selected can be defined based on: demographic information (education, nationality, ethnicity, age, location, income status, etc.), purchase information (purchase history, frequency, amount, bundle subscription status, etc.), social characteristics (social network usage, social network connections, etc.), device usage characteristics (watch usage, application usage, etc.), and/or any other suitable criteria. Defined user populations can be manually determined, automatically determined, dynamically adjusted, and/or determined in any suitable manner.

In a first variation, selecting a user population can include displaying a set of user populations associated with the third party account on the third party device. In this variation, the third party can select from a pool of predefined user populations. For example, a third party watch brand can select from user populations defined based on the watch type that the user owns (e.g., basic watch line, premium watch line, etc.).

In a second variation, a third party is permitted to define their own user population for which to make a bundle available. A third party can select specific users, groups of users, criteria, and/or select based on any other suitable information. For example, exclusive bundles can be directed to select individual users. In a third variation, user populations are automatically determined (e.g., through a machine learning model). Automatic determination can be based on assets, templates, template components, third-party selected preferences (e.g., targeting high-spending users, targeting users at specific locations, etc.), and/or any suitable criteria.

An alternative embodiment preferably implements the above methods in a computer-readable medium storing computer-readable instructions. The instructions are preferably executed by computer-executable components preferably integrated with a user interface configuration system. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method enabling a third party to dynamically reskin information displayed at a smartwatch associated with a user account, the method comprising:
transmitting, to a third party device, a template for a user interface of the smartwatch, the template comprising a first variable associated with a variable value set, the template associated with a feature of the smartwatch;
receiving, at a remote server, a bundle from the third party device, the bundle comprising a graphical asset associated with a first variable value of the variable value set;
delivering the bundle to the smartwatch;
selecting the first variable value of the variable value set based on contextual information associated with the first variable, the contextual information corresponding to a predetermined timeframe; and
in response to the smartwatch effectuating the feature, rendering, at the smartwatch, the graphical asset associated with the variable value.

2. The method of claim 1, wherein the template comprises a plurality of arcuately defined positions on the template, wherein the first variable is associated with an arcuately defined position of the plurality of arcuately defined positions, and wherein the smartwatch renders the graphical asset at the arcuately defined position.

3. The method of claim 1, wherein delivering the bundle to the smartwatch comprises:
transmitting the bundle from the remote server to a secondary user device associated with the user account, the secondary user device configured to notify the user with a bundle notification, wherein the bundle is transmitted through a first wireless connection type; and
receiving the bundle at the smartwatch from the secondary user device.

4. The method of claim 3, wherein receiving the bundle from the secondary user device comprises:
receiving a user response to the bundle notification, the user response authorizing receipt of the bundle; and
in response to receipt of the user response, receiving, at the smartwatch, the bundle from the secondary user device through a second wireless connection type different from the first wireless connection type.

5. The method of claim 3, further comprising, rendering a secondary user interface based on the bundle at an application on the secondary user device.

6. The method of claim 1,
wherein the template comprises a plurality of layers, each layer comprising a plurality of layer positions;
wherein the first variable is associated with a first layer position at a first layer of the plurality;
wherein the graphical asset is associated with the first layer position; and
wherein the method further comprises automatically associating, at the third party device, the graphical asset with the first variable based on the association between the graphical asset set and the first layer position.

7. The method of claim 6:
wherein a second variable is associated with a second layer position at a second layer of the plurality;
wherein a second graphical asset is associated with the second layer position;
wherein the method further comprises automatically associating, at the third party device, the second graphical asset to the second variable based on the association between the second graphical asset and the second layer position; and
wherein rendering the user interface comprises rendering the user interface based on the second graphical asset.

8. A method enabling a third party device associated with a third party account to dynamically configure information displayed at a primary user device of a user, the method comprising:
transmitting, to the third party device, a template for a user interface of the primary user device, the template associated with a feature of the primary user device, the template comprising:
a predefined set of restricted virtual areas and a predefined set of customizable virtual areas, each virtual area mapped to a template position of a template position set, and
a variable associated with a variable value set, the variable mapped to a customizable virtual area of the customizable virtual area set;
receiving an asset associated with the template from the third party device;
generating a bundle associating the asset with a variable value of the variable value set;
receiving the bundle at the primary user device;
configuring the user interface based on the template and the bundle; and
in response to the primary user device effectuating the feature, presenting the user interface at the primary user device.

9. The method of claim 8, wherein the asset is a graphical asset.

10. The method of claim 9, further comprising:
populating the customizable virtual area with the graphical asset;
wherein presenting the user interface at the primary user device comprises the primary user device rendering the populated customizable virtual area at the user interface.

11. The method of claim 10, wherein populating the customizable virtual area comprises:
determining a variable value of the variable value set based on contextual information associated with the variable, the contextual information corresponding to a predetermined timeframe, and
populating the customizable virtual area with the graphical asset associated with the variable value.

12. The method of claim 9, wherein the template position set comprises a plurality of arcuately defined positions on the template, wherein the variable is associated with an arcuately defined position of the plurality of arcuately defined positions, and wherein the primary user device renders the graphical asset at the arcuately defined position.

13. The method of claim 12,
wherein the graphical asset is associated with a variable value of the variable value set;
wherein the method further comprises: determining the variable value based on a volume of contextual information received within a predetermined timeframe, the contextual information associated with the variable; and
wherein presenting the user interface comprises rendering the graphical asset associated with the variable value.

14. The method of claim 8,
wherein the template comprises a plurality of layers, each layer comprising a plurality of layer positions of the template position set;
wherein the variable is associated with a layer position on a layer of the plurality of layers;
wherein the asset is received in association with the first layer position; and
wherein the method further comprises: after receiving the asset, automatically associating the asset with the variable based on the association between the variable and the first layer position.

15. The method of claim 14, wherein the remote server receives the asset from the third party device and automatically associates the asset with the variable.

16. The method of claim 15, further comprising, after automatically associating the asset with the variable, generating the bundle at the remote server, the bundle comprising the asset and the association between the asset and the variable.

17. The method of claim 8, further comprising delivering the bundle to a secondary user device configured to wirelessly communicate with the primary user device, wherein receiving the bundle at the primary user device comprises receiving the bundle from the secondary device.

18. The method of claim 17, further comprising:
configuring a secondary device user interface based on the template and the bundle; and
presenting the secondary device user interface at the secondary user device.

19. The method of claim 8, further comprising receiving a user population selection from the third party device, wherein the primary user device is associated with a user account within the selected user population.

20. The method of claim 19, further comprising:
verifying the third party account as an authorized account eligible to configure the user interface; and
displaying a set of user populations associated with the third party account on the third party device in response to verification of the third party account, wherein the selected user population is one of the set of user populations.
